(19) United States
(12) Patent Application Publication
(10) Pub. No.: US 2014/0125269 A1
(43) Pub. Date: May 8, 2014

(54) WINDING SWITCHING CIRCUIT AND THERMAL PROTECTION FOR DUAL VOLTAGE HERMETIC INDUCTION MOTOR OF HERMETIC COOLING COMPRESSOR

(71) Applicants: Flavio J.H. Kalluf, Joinville SC (BR); Aleandro Amauri De Espindola, Joinville SC (BR)

(72) Inventors: Flavio J.H. Kalluf, Joinville SC (BR); Aleandro Amauri De Espindola, Joinville SC (BR)

(73) Assignee: WHIRLPOOL S.A., Sao Paulo (BR)

(21) Appl. No.: 14/001,509

(22) PCT Filed: Feb. 24, 2012
(86) PCT No.: PCT/BR12/00039

§ 371 Date: Jan. 9, 2014

(30) Foreign Application Priority Data
Feb. 25, 2011 (BR) PII101882-8

(51) Int. Cl. H02P 25/18

(52) U.S. Cl. CPC H02P 25/188
USPC 318/497

(57) ABSTRACT

A winding switching circuit and thermal protection for dual voltage hermetic induction motors used in hermetic cooling compressors. The circuit includes two coils of the main winding, an auxiliary winding, three switches that are connected based on desired connections for each of the power arrangements, a start-up relay and thermal protection devices that protect the two main windings from overheating. The circuit is operative in first and second arrangements. In the first arrangement, the first switch and the third switch are connected, the second switch is disconnected, and the first main winding, and second main winding and the auxiliary winding are connected in parallel. In the second arrangement, the first switch and the third switch are disconnected, the second switch is connected, and the first main winding and the second main winding are connected in series and the auxiliary winding is connected in parallel only to the second main winding.

The present invention refers to a winding switching circuit and thermal protection for single phase dual voltage induction motors, normally, used in hermetic compressors for cooling, which allows the motors to operate within the entire voltage range between approximately 90 and 260 V.

### DESCRIPTION OF THE STATE OF THE ART

Single phase induction motors used in hermetic compressors for cooling are normally designed so as to enable them to be used in a limited voltage range. Typically, the design allows from 10% subvoltage to 10% overvoltage to be applied to the motor. This means that a motor designed for 115V should function without problems when a range of 103V to 127V is applied thereto. For voltage variations in excess of 10%, it is not possible to use the same project, and a new windings arrangement must be used for this voltage.

Another factor which hampers the use of a same windings circuit project for a broad range of voltages is the specification of the other electrical components such as capacitors, relays, thermal protectors, etc., which are normally sized to function inside a limited voltage variation, and may lose the functionality when submitted to voltages outside this range.

Most energy concessionaires around the world supply low tensions of 115-127V (USA, Brazil and others) or 220-240V (Europe, China and others). This difference requires that electric motors be customized for each voltage.

Some arrangements for single phase induction motors of the dual voltage type that are capable of operating with voltages of 115-127V or 220-240V are already known in the state of the art.

Single phase induction motors have a primary winding and a secondary winding through which currents circulate with a phase gap that drive and power the motor stator. In induction motors of the dual voltage type, two primary windings M1 and M2 and a secondary winding A are used. When a voltage of approximately 115V is applied to the motor, the two primary windings M1 and M2 are connected in parallel, as shown in FIG. 1A, whereas for a power voltage of 220V, the two primary windings M1 and M2 should be connected in series, as shown in FIG. 1B. These circuit arrangements are based on the T-connection principle, shown in FIGS. 2A and 2B in 115V and for 220V arrangements. Accordingly, it is necessary to provide the switching of the connection in series for the connection in parallel of the primary windings M1 and M2, depending on the power voltage.

The T-connection is a simple way of ensuring the viability of the voltage change of the electric motor without the need for different designs for voltages near 115V and for voltages of about 220V. The main windings and the auxiliary winding are exactly the same both for 115V and for 220V, which enables the motor design to be standardized, eliminating the need to create codes and facilitating manufacturing logistics.

However, in motors for hermetic compressors, the access to the compressor terminals is limited, being normally by way of a hermetic 3-pin terminal. This hampers the application of T-connection circuits, as there is no possibility of independent access to the terminals of the windings M1 and M2, unless a new terminal with a greater number of pins is used.

In the T-connection known in the state of the art, even if it is possible to use the same design of the main and auxiliary windings for power of 115V or 220V, other electric components connected to the circuit, such as relay, capacitors and thermal protector, are different for each voltage applied.

There is therefore no type of arrangement used to-date in hermetic compressors for cooling that can use the same arrangement of electric devices for voltages of 115V and 220V, which requires specific arrangements for each voltage range, increasing the number of engineering codes, adversely affect the manufacture, distribution and control logistics.

Some documents of the state of the art show winding circuit arrangement alternatives that perform switching between the 115V and 220V arrangements.

Patent document JP61102189 discloses a pump controlled by a motor with automatic switching between voltages of 220V and 115V. The motor has an auxiliary circuit to adapt to the two voltages. The circuit has an auxiliary winding and two main winding combinations. When the power voltage is 115V, the relays are commuted, such that the two combinations of main windings are connected in parallel. When the power voltage is 220V, the relay is commuted and places the two main windings connected in series. The commutation between the mode 115V and the mode 220V is performed by a complex circuit of various relays. In all the arrangements shown in this patent document, the positive poles of the two main windings are directly connected together.

Patent document U.S. Pat. No. 5,867,005 discloses a motor circuit that is also adapted to allow the motor to operate with 115V or 220V. The circuit has first and second main windings and an auxiliary connection with an auxiliary winding permanently connected in series with a capacitor. In a first arrangement with lower input voltage, the first main winding and the second main winding are connected in parallel and a power voltage of about 115V is applied on the first main winding. In a second arrangement for input voltage of 220V, the first and second main windings are connected in series. A power voltage is applied on the first and second main windings. The circuit has an integrated circuit that functions as commuter connected to the main windings to perform this commutation. In all the arrangements shown in this patent document, the positive poles of the two main windings are directly connected together. Hence, this circuit arrangement presents the drawback that the number of poles is not the same in the arrangements 115V and 220V.

Patent document GB632468 shows an improvement in single phase dual voltage motors, wherein a main winding is divided into two windings, preferably, wound on all the motor poles. An auxiliary winding is connected with phase gap in parallel with the main winding, and is also connected in series with a capacitor. In the connection for the power voltage of 220V, the main windings are connected in series in relation to the power terminals, and the auxiliary winding is connected in parallel to the main winding. In the connection with power voltage of 115V, the main windings are connected together in parallel and in relation to the power terminals, and the auxiliary winding is connected in parallel to the main terminals. The change between the two connection arrangements is performed by a current relay.

All the circuits described in these prior arts are based on the T connection and use different connection arrangements between the windings, relays and capacitors to adapt to the power voltages of 115V and 220V.

However, none of the motors of the state of the art is a hermetic motor and therefore does not need to use hermetic terminals, not offering the limitations of access to the pins that exists in the case hermetic motors of the kind of the present invention. In addition, the use of hermetic terminals with independent pins for each branch of the main coil requires protection against overheating to be performed separately for the two branches of the main windings. None of these circuits of the state of the art proposes winding circuit connection arrangements for inductive motors also using their own thermal protectors for each winding that operate in the two arrangements (115V and 220V), and therefore they are susceptible to damage caused by overheating. In the motors of the state of the art documents that are not hermetic, the protection could be in series with the power, therefore, they would not need two protectors connected between the other components of the windings circuit of the motor. The coupling of thermal protectors to the windings circuit ultimately increases its complexity and hampers the switching between the 115V and for 220V arrangements.

### OBJECTIVES OF THE INVENTION

An objective of the invention is to provide a winding switching circuit and thermal protection for dual voltage induction motors that are suited for use in hermetic compressors and susceptible to change the 115V arrangement to the 220V arrangement by using the same electric components and with independent thermal protection for the two main coils.

It is also an objective of the invention to provide a winding switching circuit and thermal protection for dual voltage induction motors that allows the induction motor to function within the entire range of 90V to 260V.

### BRIEF DESCRIPTION OF THE INVENTION

The objectives of the invention are achieved by way of a winding switching circuit and thermal protection for a single phase two voltage hermetic induction motor of a hermetic cooling compressor, which comprises:

a first main winding with the negative pole connected to a first node and the positive pole connected to a second node, a second main winding with the positive pole connected to a third node, and the negative pole connected to a fourth node, a first switch connected between the second node and the third node, and a start-up relay connected to the third node, an auxiliary winding with the positive pole connected to the start-up relay and the negative pole connected to the fourth node, and the auxiliary winding is connected in parallel with the second main winding, a second switch connected between the third node and the first node, a third switch connected between the first node and the fifth node, and a voltage source connected between the second node and the fifth node;

wherein the circuit is operative in a first and in a second arrangements, where in the first arrangement, the first switch and the third switch are connected, the second switch is disconnected, and the first main winding, the second main winding and the auxiliary winding are connected in parallel;

in the second arrangement, the first switch and the third switch are disconnected, the second switch is connected, the first main winding and the second main winding are connected in series and the auxiliary winding is connected in parallel only to the second main winding, and

the circuit comprises thermal protection means that perform the thermal protection of the first and second main windings (M1, M2) in the first and in the second arrangements.

The circuit is operative in a voltage range between 90V and 260V, and preferably the first arrangement operates in a voltage range nearer 115V and the second arrangement operates in a voltage range nearer 220V.

The thermal protection means may comprise a single thermal three-phase protector having three terminals, one terminal being connected to the positive pole of the first main winding, one terminal connected to the first switch and one terminal connected to the positive pole of the power supply.

Alternatively, the thermal protection means may comprise a first thermal protector connected between the positive pole of the power supply and the second node, and a second thermal protector connected between a first switch and the second switch. Also alternatively, the thermal protection means comprise a first thermal protector connected between the positive pole of the first main winding and the second node, and a second thermal protector connected between the fourth node and the fifth node. Also alternatively, the thermal protection means comprise a first thermal protector connected between the negative pole of the power supply and the fifth node, and a second thermal protector connected between the fifth node and the terminal 5.

The thermal protection means can be disposed internally of the shell of the circuit, in contact with the main windings, and be opened when the temperature of the windings exceeds a threshold value, or else they may be disposed externally of the shell of the circuit, and be opened when the current of the compressor exceeds a threshold value. The switches can be driven mechanically, and may be electronic switches or may be electromechanical relays controlled by way of an electronic circuit.

Preferably, the first and second main windings are divided into two equal parts, one on each side of the stator, being connected in series, containing the same number of coils per groove. Accordingly the magnetic flow generated by each half of each winding is balanced.

The windings circuit may be disposed inside a hermetic shell of the compressor which comprises a hermetic five-pin terminal, and the first pin is located in the positive pole of the first main winding; the second pin is coupled between the negative pole of the first main winding and the first node; the third pin is coupled between the positive pole of the second main winding and the third node; the fourth pin is coupled between the positive pole of the auxiliary winding and the start-up relay; and the fifth pin is located between the fifth node and the fourth node.

### BRIEF DESCRIPTION OF THE DRAWINGS

The present invention will now be described in further detail based on an example of execution represented in the drawings. The drawings show:

FIGS. 1A and 1B—are diagrams of connections of a windings circuit in the arrangements for power voltages of 115V and 220V of the kind used in the state of the art;

FIGS. 2A and 2B—are diagrams of the T-connection arrangements according to the state of the art for power voltages of 115V and 220V;

FIGS. 3A and 3B—are diagrams of a first embodiment of the connections of the winding switching circuit and thermal protection of the present invention in the arrangements for power voltage of 115V and 220V;

FIG. 4—is a schematic view of the disposition of the coils of the main windings of the circuit of the present invention in the induction motor;

FIG. 5—is a diagram of a second embodiment of connections of the winding switching circuit and thermal protection of the present invention for power voltages of 115V and 220V, with the use of a thermal three-phase protector for protecting the circuit;

FIGS. 6 and 7—are diagrams of the third and fourth alternative embodiments of connections of the winding switching circuit and thermal protection of the present invention for power voltages of 115V and 220V, with the use of two thermal protectors dedicated to protecting the circuit.

### DETAILED DESCRIPTION OF THE DRAWINGS

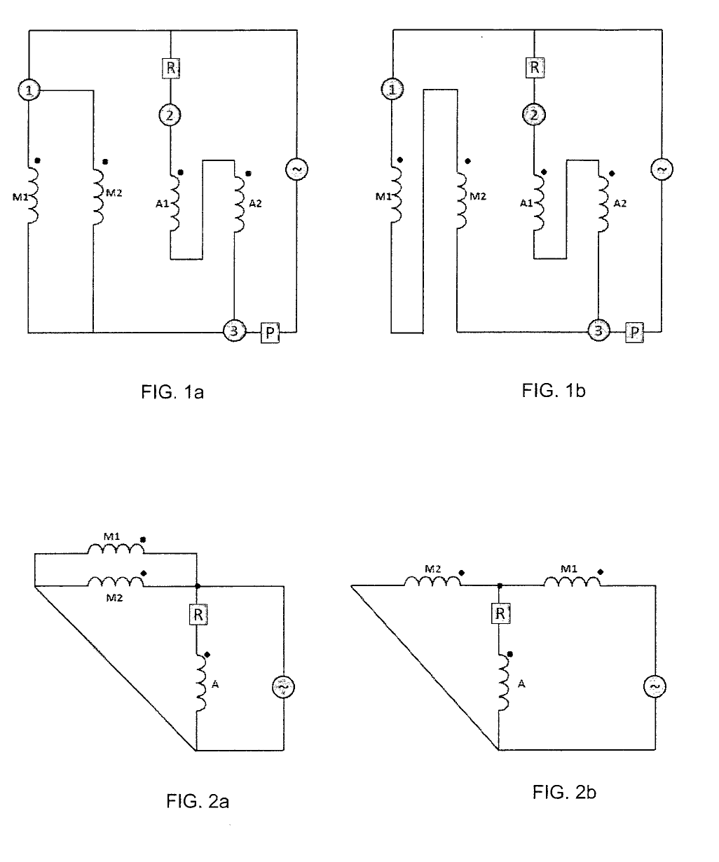

As can be seen in FIGS. 1a and 1b, the circuits of the state of the art for single phase dual voltage induction motors use three connection pins 1, 2 and 3, a main coil with two main windings M1 and M2 that are connected between the pins 1 and 3, and the windings M1 and M2 are connected in parallel for a power voltage of 115V and in series for a power voltage of 220V. The auxiliary coil represented by the two coil parts A1, A2 is connected between the pins 2 and 3, in parallel with the main coil, either in the arrangement wherein the two main windings are in series or in parallel. In addition, in some cases, a single thermal protector P is connected between the negative terminal of the power supply and the pin 3. This single thermal protector alone performs the thermal protection of the two main windings M1 and M2. A start-up relay R is connected in series with the auxiliary coil A before the pin 2.

As mentioned in the description of the prior art, this circuit arrangement requires the auxiliary coil to have different characteristics for powers of 115V or 220V, having to be changed from one arrangement to the other. This is because the entire voltage of the power supply, which varies from 115V to 220V, is always applied thereto.

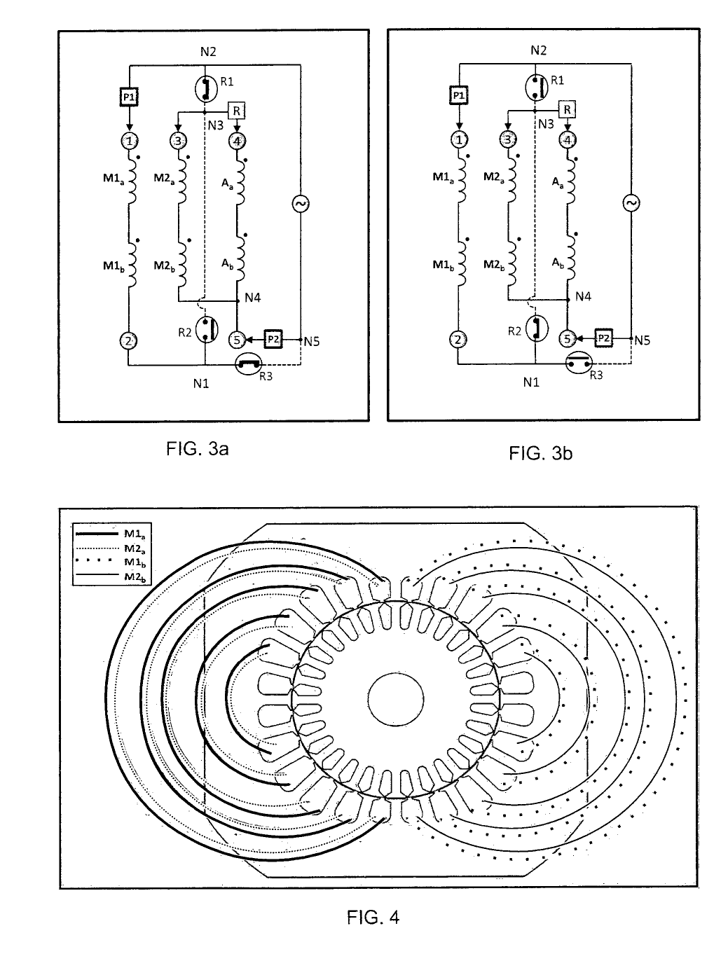

FIGS. 3A and 3B show a first embodiment of the arrangements of the winding switching circuit and thermal protection of the present invention respectively for power voltages of 115V and 220V. It should be noted that the same electric components are used in both arrangements, and it is only the electrical connections between the components that are changed from one arrangement to the other by means of switches that open and close.

The circuit according to the present invention uses five connection pins 1, 2, 3, 4, 5 in a hermetic terminal, instead of just the three pins used in the circuits of the state of the art. The circuit comprises a main winding with two coils M1 and M2, and an auxiliary winding A. In FIGS. 3A and 3B, each coil of the main winding M1 and M2 is represented by two independent coil parts, M1ₐ M1_{b}, M2ₐ M2_{b}, representing the two poles of the motor. The coil of the auxiliary winding is also represented the two independent coils Aₐ and A_{b}. The circuit also comprises a start-up relay R and three switches R1, R2 and R3 that are connected and disconnected based on the desired connections for each of the arrangements (power of 115V or 220V). In addition, the circuit comprises thermal protection means that are connected to the other components of the circuit such that they perform the thermal protection against overheating of the first and second main windings M1, M2 in both the arrangements of 115V and 220V. The thermal protection means may be in the form of a single thermal three-phase protector P or in the form of two independent thermal protectors P1, P2.

In the circuit arrangements shown in FIGS. 3A, 3B, 5, 6 and 7, the circuit points to which more than one device is connected were identified as nodes N1, N2, N3, N4 and N5, in order to facilitate the understanding of the circuit connections.

The circuit essentially functions in two arrangements that vary based on whether the switches R1, R2, R3 are open or closed and that can be seen in FIGS. 3A and 3B. However, the connections of the circuit described ahead are common to two preferred operating arrangements.

The first coil of the main winding M1, represented by the independent coils M1ₐ and M1_{b}, is disposed with the negative pole connected to a first node N1 and the positive pole connected to a second node N2. This first main coil is connected between the pins 1 and 2, and the negative pole connected to the pin 1 and the positive pole connected to the pin 2.

The second coil of the main winding M2, represented by the independent coils M2ₐ and M2_{b}, is disposed with the positive pole connected to a third node N3, and the negative pole connected to a fourth node N4. The positive pole of the coil M2ₐ is also connected to the pin 3 of the hermetic terminal.

The auxiliary winding A, represented by the independent coils Aₐ and A_{b}, is disposed with the positive pole connected to the start-up relay R and the negative pole connected to the fourth node N4. The start-up relay R is also connected to the third node N3. Accordingly the auxiliary winding A is connected in parallel to the second main winding M2. The pin 4 of the hermetic terminal is coupled between the start-up relay and the positive pole of the coil Aₐ.

The first switch R1 is connected between the second node N2 and the third node N3. The second switch R2 is connected between the third node N3 and the first node N1. The third switch R3 is connected between the first node N1 and the fifth node N5. The pin 5 is located between the fourth node N4 and the fifth node N5. The voltage source is connected between the second node N2 and the fifth node N5.

The connections identified above are used in all four embodiments of the invention described here and shown in FIGS. 3a, 3b, 5, 6 and 7, in the 115V and 220V power arrangements. It is only the connections with the thermal protection means that vary between each of the embodiments.

In this first embodiment of the invention of FIGS. 3a, 3b, two independent thermal protectors, P1 and P2, are used. The first thermal protector P1 is connected between the second node N2 and the pin 1 of the hermetic terminal, thus being connected to the positive pole of the first main winding. The second thermal protector P2 is connected between the fourth node N4 and the fifth node N5, thus being connected to the negative pole of the second main winding M2 and of the auxiliary winding A.

In the 115 V power arrangement shown in FIG. 3A, the first switch R1 and the third switch R3 are connected, and a second switch R2 is disconnected. Since the third switch R3 is closed (connected), the nodes N1 and N5 are connected together and the second thermal protector P2 is connected between the pins 2 and 5. In addition, the connected switch R1 forms a short circuit between the nodes N2 and N3. By way of this arrangement, the coils M1 and M2 are in parallel. The auxiliary coil A is also in parallel with the main coils M1 and M2. Since all the coils M1, M2 and A are connected in parallel between the nodes N2 and N5 (or node N1 which is short-circuited with node N5), to which the voltage source is also connected, so in this arrangement, all the coils are submitted to the same source voltage, normally about 115V. In this arrangement, each thermal protector P1 and P2 will be protecting a branch of the main coil (P1 protects M1 and P2 protects M2). It can be noted that the poles of the main coils M1 and M2 are not connected directly together, as the thermal protector P1 is connected between the two poles. Therefore, the number of poles is kept the same both in the 115V arrangement as in the power arrangement of 220V.

In the connection for a power of 220V, the changes in the connections between the circuit components are caused by the change in the status of the switches. The switches R1 and R3 are disconnected/open, and only the switch R2 is connected/closed. Thus, the nodes N1 and N3 are connected in short-circuit. The pin 2 of the hermetic terminal is thereafter connected to the start-up relay R and to the pin 3. Since the switch R1 is open, the nodes N2 and N3 are not connected together. In addition, with the third switch R3 open, the nodes N1 and N5 are disconnected from each other, such that the negative pole of the first main coil M1 is no longer connected with the negative pole of the voltage source. Hence, the coils M1 and M2 are connected in series. The auxiliary coil A remains connected to the pin 4 and to the start-up relay R, but since the switch R1 is open and the switch R2 is closed, the positive pole of the auxiliary coil A is thereafter connected, by way of the pin 4 and the start-up relay R, to the point between the negative pole of the first main coil M1 and the positive pole of the second main coil M2, more specifically in the third node N3, at the point of division of voltage between the coils M1 and M2. Therefore, the auxiliary coil is submitted to a voltage of approximately 115V, or approximate value corresponding to the voltage divider of the two main coils M1 and M2, which depends on the design of each coil. In this arrangement, since the switches R1 and R3 are disconnected, only the second node N2 is connected to the positive pole of the power supply, and consequently, the first thermal protector P1 is connected between the power supply and the positive terminal of the first main coil M1. The negative pole of the power supply is connected to the fifth node N5, to the thermal protector P2, to the pin 5 and lastly to the fourth node N4, all in series. The negative poles of the main winding M2 and of the auxiliary winding A are also connected to the fourth node N4, and, therefore, are protected by the second thermal protector P2 connected in series with the fourth node N4. Therefore, the power voltage of 220V is only applied to the connection in series of the main windings M1 and M2. The protectors P1 and P2 are connected in series with the coils M1 and M2, both protecting the two at the same time.

The present invention also permits some alternative form of connecting thermal protectors to the circuit, achieving the same independent protection objective for the two branches of the main coils of the motor in both arrangements of 115V and 220V.

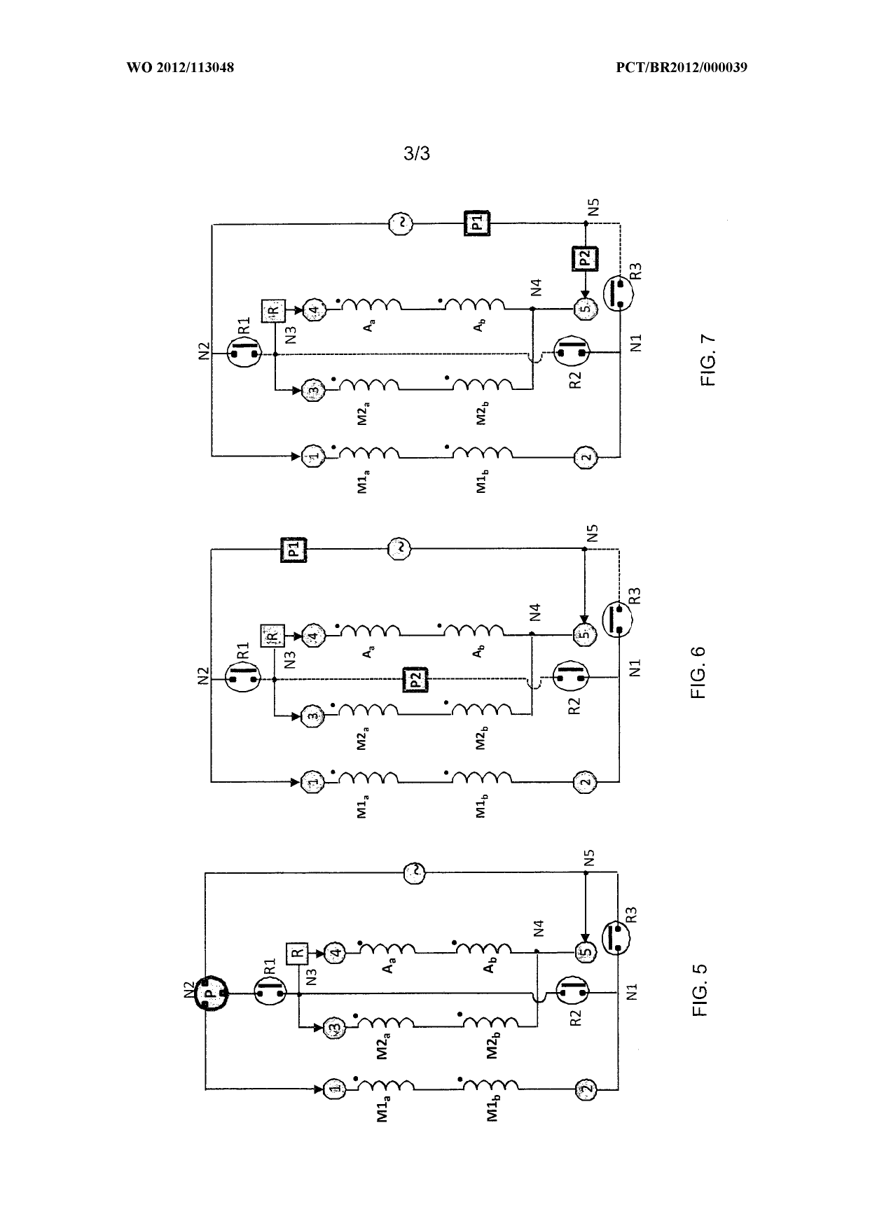

In the alternative arrangement shown in FIG. 5, the thermal protection is performed by the use of a single thermal three-phase protector P having three terminals, such that a first terminal is connected to the pin 1 of the hermetic terminal and to the positive pole of the first main winding M1, a second terminal is connected to the first switch R1 and a third terminal is connected to the positive pole of the power supply. This thermal protector can be located in the position of the second node N2. When the first switch R1 is closed in the power arrangement with about 115V, the thermal three-phase protector is connected to the positive poles of both the main windings M1 and M2. When the first switch R1 is opened and the second switch R2 is closed, the thermal protector P is connected between the positive pole of the power supply and the positive pole of the first winding M1, and performs the protection of the two main windings M1 and M2 which are connected in series by way of the switch R2.

In another alternative arrangement of the invention shown in FIG. 6, a thermal protection is performed by the use of two thermal protectors P1 and P2 dedicated to each voltage, P1 being sized for the current of 115V and P2 sized for the current of 220V. The first thermal protector P1 is connected between the positive pole of the power supply and the second node N2, also being connected to the positive pole of the first main winding M1. A second thermal protector P2 is connected between a first switch R1 and the second switch R2, and may be located between the third node N3 and the second switch R2. Accordingly, when the switches are arranged for the connection 115V, with the first and the third switches R1 and R3 closed and the second switch R2 open, the protector P2 will be outside the circuit, disconnected by the second switch R2, and the single protector in the circuit will be P1, which will be in series with the power supply. In contrast, when the switches are arranged for the connection 220V (first and third switches R1 and R3 open and the second switch R2 closed), the protector P2 will be active and in series between the two main windings M1 and M2, and the protector P1, although still in the circuit, will not have an active function because it is subject to a very low current for which it was sized.

In another alternative arrangement of the invention shown in FIG. 7, the same principle as the arrangement of FIG. 6 is used, but with the use of a protector P1 connected between the negative pole of the power supply and the node N5, and the second protector P2 being connected between the fourth node N4 and the fifth node N5. In the power arrangement of 115V, with the switches R1 and R3 closed, and the switch R2 open, the second thermal protector P2 protects the second main winding M2 and the second thermal protector P1 protects the first main winding M1. In the power arrangement of 220V, with the switches R1 and R3 open, and the switch R2 closed, the first and the second thermal protectors P1 and P2 are connected in series and after with the first and the second main windings M1 and M2 and perform the thermal protection of both windings.

Although the arrangements above are appropriate for values near 115V and 220V, the circuit is operative in the entire voltage range between 90V and 260V.

The thermal protectors P1 and P2 may be disposed internally of the shell of the circuit, in direct contact with the main coils M1 and M2. The devices used as thermal protectors in this embodiment of the invention are temperature-sensitive and owing to their disposition, they directly sense the temperature level of the coils, and open the circuit when this temperature reaches a certain threshold value, whereby avoiding overheating of the coils.

Alternatively, the thermal protectors P1 and P2 are disposed externally of the shell of the circuit, preferably being fixed on the outer side of the compressor, with the shell. These thermal protectors normally function by monitoring the temperature of the shell and the current of the compressor, such that when the temperature of the shell and/or the current of the compressor exceeds a threshold value, the protectors open and interrupt the circuit. In a preferred form, the current of the compressor passes through the internal circuit of the thermal protector and heats a resistance that is disposed just below a bimetal disk. When the current is lower, the heating of the resistance is also lower, and, therefore, is not sufficient to heat the bimetal disk. However, when the current of the compressor increases and exceeds a threshold value which might correspond to overheating of the circuit, the bimetal disk is also more heated and flexes, opening the circuit and interrupting the current.

According to the present invention, the switches R1, R2 and R3 used in the circuit can be manual switches driven mechanically. Electronic switches can also be used, such as solid state devices, which open or close depending on the value of the power voltage, or the switches R1, R2, R3 may be electromechanical relays controlled by way of an electronic circuit.

FIG. 4 shows how the coils of the main coils M1 and M2 are disposed in the motor in the form of two independent coil parts, M1ₐ M1_{b}, M2ₐ M2_{b}. Normally, these independent coil parts are coiled in sequence, without interruption of the wire. However, according to the present invention, each coil M1, M2 of the main winding should be divided into two equal independent parts M1ₐ M1_{b}; M2ₐ M2_{b}. The independent parts of a same coil contains the same number of coils per groove, are connected in series and are each disposed on one side of the stator. Accordingly, the magnetic flow generated by each half of each winding is balanced.

Thus, the first branch M1 is subdivided into two parts, the first part M1ₐ of the first coil being disposed on one side of the stator and the second part M1_{b} of the first coil disposed on the opposite side of the stator. The two coils of the second branch are disposed in the same manner, the first part M2ₐ being disposed on the same side of the stator as first part M1ₐ of the first coil, and the second part M2_{b} of the second coil disposed on the same side of the stator as the second part M1_{b} of the first coil. The auxiliary winding is not altered, and remains with the coils of each pole connected in series. This disposition allows that there is no flow imbalance between the stator poles, which may lead to performance loss and to the creation of harmonic torques.

One of the major advantages of the winding switching circuit and thermal protection of the present invention is the possibility of using the same electrical devices, such as coils, start-up relays, capacitors (not illustrated) and thermal protectors both for voltages in the range of 115 to 127V as in the range of 220 to 240V, facilitating maintenance, reducing the stock of components and reducing the engineering code numbers, facilitating production and distribution logistics. In addition, this circuit allows the thermal protection of the main windings M1 and M2 to be performed separately for each of the windings and operating both for 115V as for 220V, only opening or closing the switches R1, R2, R3, with the thermal protectors being disposed internally or externally of the shell.

Having described an example of a preferred embodiment, it must be understood that the scope of the present invention encompasses other possible variations, being limited only by the content of the accompanying claims, potential equivalents being included therein.

1. A winding switching circuit and thermal protection for single phase dual voltage hermetic induction motor of a hermetic cooling compressor, said circuit comprising:
a first main winding (M1) with a negative pole connected to a first node (N1) and a positive pole connected to a second node (N2),
a second main winding (M2) with a positive pole connected to a third node (N3), and a negative pole connected to a fourth node (N4),
a first switch (R1) connected between the second node (N2) and the third node (N3), and a start-up relay (R) connected to the third node (N3),
an auxiliary winding (A) with a positive pole connected to the start-up relay (R) and a negative pole connected to the fourth node (N4), wherein the auxiliary winding (A) is connected in parallel with the second main winding (M2),
a second switch (R2) connected between the third node (N3) and the first node (N1),
a third switch (R3) connected between the first node (N1) and the fifth node (N5), and
a voltage source connected between the second node (N2) and the fifth node (N5);
wherein the circuit is operative in a first arrangement and in a second arrangement, where:
in the first arrangement, the first switch (R1) and the third switch (R3) are connected, the second switch is disconnected, and the first main winding (M1), the second main winding (M2) and the auxiliary winding (A) is connected in parallel;
in the second arrangement, the first switch (R1) and the third switch (R3) are disconnected, the second switch (R2) is connected, the first main winding (M1) and the second main winding (M2) are connected in series and the auxiliary winding (A) is connected in parallel only to the second main winding (M2); and,
the circuit further comprising thermal protection means (P,P1,P2) for thermal protection of the first and second main windings (M1, M2) in the first and in the second arrangements, each of the thermal protection means (P,P1,P2) comprising a resistance.

2. A winding switching circuit and thermal protection according to claim 1, wherein the circuit is operative in a voltage range between 90V and 260V, and the first arrangement operates in a voltage range nearer to 115V than 220V and the second arrangement operates in a voltage range nearer to 220V than 115V.

3. A winding switching circuit and thermal protection according to claim 1, wherein the thermal protection means comprise a single thermal three-phase protector (P) having three terminals, one terminal being connected to the positive pole of the first main winding (M1), one terminal connected to the first switch (R1) and one terminal connected to the positive pole of the power supply.

4. A winding switching circuit and thermal protection according to claim 1, wherein the thermal protection means comprise a first thermal protector (P1) connected between the positive pole of the power supply and the second node (N2), and a second thermal protector (P2) connected between the first switch (R1) and the second switch (R2).

5. A winding switching circuit and thermal protection according to claim 1, wherein the thermal protection means comprise a first thermal protector (P1) connected between the positive pole of the first main winding (M1) and the second node (N2), and a second thermal protector (P2) connected between the fourth node (N4) and the fifth node (N2).

6. A winding switching circuit and thermal protection according to claim 1, wherein the thermal protection means comprise a first thermal protector (P1) connected between the negative pole of the power supply and the fifth node (N5), and a second thermal protector (P2) connected between the fourth node (N4) and the fifth node (N5).

7. A winding switching circuit and thermal protection according to claim 1, wherein the thermal protection means (P; P1, P2) are disposed internally of the shell of the circuit, in contact with the first and second main windings (M1, M2), and are opened when the temperature of the windings exceeds a threshold value.

8. A winding switching circuit and thermal protection according to claim 1, wherein the thermal protection means (P; P1, P2) are disposed externally of the shell of the circuit, and are opened when the current or the temperature of the compressor shell exceeds a threshold value.

9. A winding switching circuit and thermal protection according to claim 1, wherein the first, second, and third switches (R1, R2, R3) are driven mechanically.

10. A winding switching circuit and thermal protection according to claim 1, wherein the first, second, and third switches (R1, R2, R3) are electronic switches.

11. A winding switching circuit and thermal protection according to claim 1, wherein the first, second, and third switches (R1, R2, R3) are electromechanical relays controlled by way of an electronic circuit.

12. A winding switching circuit and thermal protection according to claim 1, wherein the first and the second main windings (M1, M2) are each divided into two independent coil parts (M1ₐ, M1_{b}; M2ₐ, M2_{b}) and connected in series, each coil part of a same winding being disposed on one side of the stator.

13. A winding switching circuit and thermal protection according to claim 1, wherein said circuit is disposed inside a hermetic shell of the compressor which comprises a hermetic five-pin terminal (1, 2, 3, 4, 5), wherein:
the first pin (1) is located in the positive pole of the first main winding (M1);
the second pin (2) is coupled between the negative pole of the first main winding (M1) and the first node (N1);
the third pin (3) is coupled between the positive pole of the second main winding (M2) and the third node (N3);
the fourth pin (4) is coupled between the positive pole of the auxiliary winding (A) and the start-up relay (R); and
the fifth pin (5) is located between the fourth node (N4) and the fifth node (N5).

14. A winding switching circuit and thermal protection according to claim 2, wherein the thermal protection means comprise a single thermal three-phase protector (P) having three terminals, one terminal being connected to the positive pole of the first main winding (M1), one terminal connected to the first switch (R1) and one terminal connected to the positive pole of the power supply.

15. A winding switching circuit and thermal protection according to claim 2, wherein the thermal protection means comprise a first thermal protector (P1) connected between the positive pole of the power supply and the second node (N2), and a second thermal protector (P2) connected between the first switch (R1) and the second switch (R2).

16. A winding switching circuit and thermal protection according to claim 2, wherein the thermal protection means comprise a first thermal protector (P1) connected between the positive pole of the first main winding (M1) and the second node (N2), and a second thermal protector (P2) connected between the fourth node (N4) and the fifth node (N2).

17. A winding switching circuit and thermal protection according to claim 2, wherein the thermal protection means comprise a first thermal protector (P1) connected between the negative pole of the power supply and the fifth node (N5), and a second thermal protector (P2) connected between the fourth node (N4) and the fifth node (N5).

18. A winding switching circuit and thermal protection according to claim 2, wherein the thermal protection means (P; P1, P2) are disposed internally of the shell of the circuit, in contact with the first and second main windings (M1, M2), and are opened when the temperature of the windings exceeds a threshold value.

19. A winding switching circuit and thermal protection according to claim 6, wherein the thermal protection means (P; P1, P2) are disposed externally of the shell of the circuit, and are opened when the current or the temperature of the compressor shell exceeds a threshold value.

20. A winding switching circuit and thermal protection for single phase dual voltage hermetic induction motor of a hermetic cooling compressor, said circuit comprising:
a first main winding (M1) with a negative pole connected to a first node (N1) and a positive pole connected to a second node (N2);
a second main winding (M2) with a positive pole connected to a third node (N3), and a negative pole connected to a fourth node (N4);
a first switch (R1) connected between the second node (N2) and the third node (N3), and a start-up relay (R) connected to the third node (N3),
an auxiliary winding (A) with a positive pole connected to the start-up relay (R) and a negative pole connected to the fourth node (N4), wherein the auxiliary winding (A) is connected in parallel with the second main winding (M2),
a second switch (R2) connected between the third node (N3) and the first node (N1),
a third switch (R3) connected between the first node (N1) and the fifth node (N5), and
a voltage source connected between the second node (N2) and the fifth node (N5);
wherein the circuit is operative in a first arrangement and in a second arrangement, where:
in the first arrangement, the first switch (R1) and the third switch (R3) are connected, the second switch is disconnected, and the first main winding (M1), the second main winding (M2) and the auxiliary winding (A) is connected in parallel;
in the second arrangement, the first switch (R1) and the third switch (R3) are disconnected, the second switch (R2) is connected, the first main winding (M1) and the second main winding (M2) are connected in series and the auxiliary winding (A) is connected in parallel only to the second main winding (M2); and,
the circuit further comprising at least one thermal protector (P;P1,P2) for the first and second main windings (M1, M2), said at least one thermal protector active in both the first arrangement and in the second arrangement and comprising a resistance.
